(19) United States
(12) Patent Application Publication
(10) Pub. No.: US 2019/0080276 A1
(43) Pub. Date: Mar. 14, 2019

(54) ALLOCATION MANAGEMENT SYSTEM

(71) Applicant: Flexport, Inc., San Francisco, CA (US)

(72) Inventors: Susanne SCHOENEBERG, Berkeley, CA (US); Nerijus POSKUS, San Francisco, CA (US); Lucas WILEY, San Francisco, CA (US)

(21) Appl. No.: 16/128,381

(22) Filed: Sep. 11, 2018

Related U.S. Application Data
(60) Provisional application No. 62/557,741, filed on Sep. 12, 2017.

(51) Int. Cl. G06Q 10/08; G06Q 10/02

(52) U.S. Cl. CPC G06Q 10/083; G06Q 10/02

(57) ABSTRACT

This disclosure relates to the freight shipping industry. In particular, this disclosure relates to a system for allocating space on vessels to transport large quantities of mass; to both satisfy shipper requirements of moving mass and for freight forwarders to maximize the potential of their carriers.

### TECHNICAL FIELD

This disclosure relates to the freight shipping industry. In particular, this disclosure relates to allocating space for the movement of mass.

### BACKGROUND

Shipping freights on large containers of goods, from one place to another, is an arduous endeavor. Many freight forwarders are faced with the difficult task of allocating all available space on a vessel, for example on a ship, plane, train, etc., in order to maximize profits, efficiency, cost and space within a container. This task is further complicated by having to rely on freight shippers to follow through with their promise to ship products after reserving space.

The current practice of securing space requires contracting for a yearly shipping volume and then trying to consistently deliver the weekly volume that adds up to the contracted yearly amount. Sometimes more or less space is needed, and changes are announced (if at all) days ahead of shipment. A short-notice period causes problems when shipments are canceled as carriers are left scrambling for freight forwarders to fill space. This outdated model presents problems for both the freight forwarder and carrier. Freight forwarders often have unpredictable shipping needs, making it difficult for a carrier to predict the volume expected. Last minute additional cargo or cancellations from freight forwarders lead to overbooked/underbooked space. As a result, carriers become reluctant to allocate space to freight forwarders who fail to fulfill their reservations and/or allocations. Shippers are often not privy to important information in how space is allocated, resulting in a loss for the shipper. Accessing and organizing information is a costly limitation for both sides.

Filling space on/in a container/vessel is also a difficult task because, depending on the type of shipment, different requirements are necessary to ship particular objects. For example, hazardous materials may require special handling, such as not being stored with food products. Filling available spaces for such large volumes, while adhering to all rules on an ad hoc basis, is complicated and allows for many mistakes and lost efficiency.

The deficiencies in the freight shipping industry derive from outdated methods at many levels of the process, including reserving and optimizing for space with a carrier on a container ship and within the container.

There exists a need for improving the efficiency of using space on container ships by using historical data to forecast and determine allocations on cargo ships. There exists a need for capturing data of past bookings, fulfillment thereof, sales pipeline, and forecast. There exists a need for enabling bookings based on allocations of input data, e.g., quote requests, booking requests, and output data (allocation-driven bookings). There exists a need for fulfillment of reservations (matching bookings and allocations, shifting, etc.), input data (booking and set allocations) and output data (maximum utilization of allocation pool fulfillment).

### BRIEF DESCRIPTION OF THE DRAWINGS

FIG. 1A is one illustrative example of Vessel 101 with Containers 102 with Slots 103.

FIG. 1B is one illustrative example of Vessel 101 on Route 108 comprising Ports 104, 105, 106, and 107 forming Loop 109.

FIG. 2 is one illustrative example of a String with three different Carriers (201, 202 and 203).

FIG. 3 is one illustrative example of a flowchart in how the system disclosed herein moves mass.

FIG. 4 is one illustrative example of a flowchart in how the Mass Shifting Engine of the disclosed system rearranges mass to optimize allocation utilization.

FIG. 5 is one illustrative example of a visual representation using a color scheme with Table 505 and colors 501, 502, 503 and 504.

FIG. 6 is one illustrative example of a visual representation using a color scheme with Table 605 and colors 601, 602, 603 and 604.

FIG. 7 is one illustrative example of how the Mass Distribution Engine optimizes percent of allocation for moving mass.

FIG. 8 is one illustrative example of a visual representation of a Carrier booking inter e comprising Allocation information.

FIG. 9 is one illustrative example of a visual representation of a Carrier booking interface comprising Allocation information and suggested bookings for optimizing Allocation.

### DETAILED DESCRIPTION

Disclosed herein is a new system for improving the efficiency of using space on one or more vessels, such as container ships, by using historical data to forecast and determine allocations on cargo ships. In one embodiment, the systems disclosed herein provide for optimizing the utilization of container ship cargo space. In one embodiment, the systems disclosed herein comprise capturing data of past bookings, fulfillment thereof, sales pipeline, and forecast. In one embodiment, the systems disclosed herein comprise enabling bookings based on allocations of input data (quote requests) and output data (allocation driven bookings).

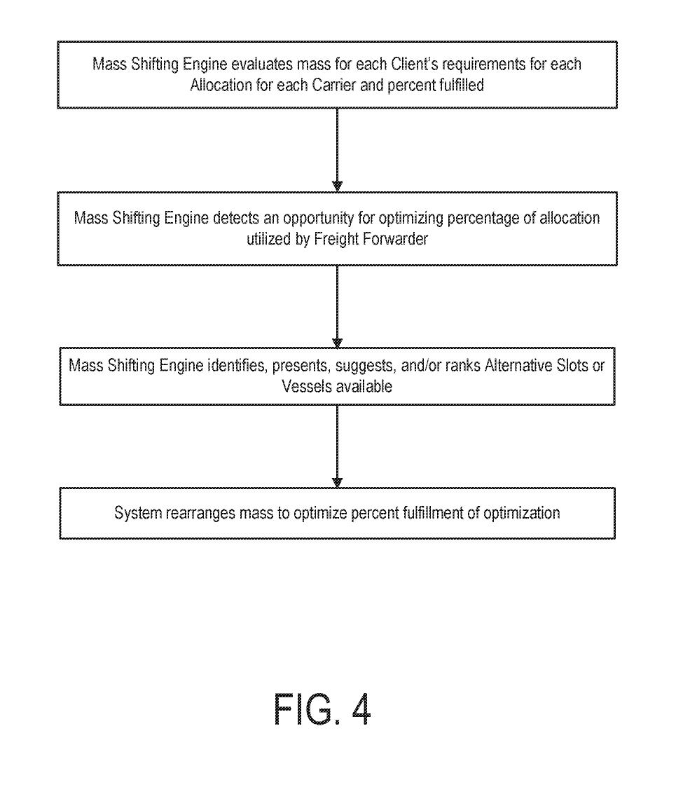

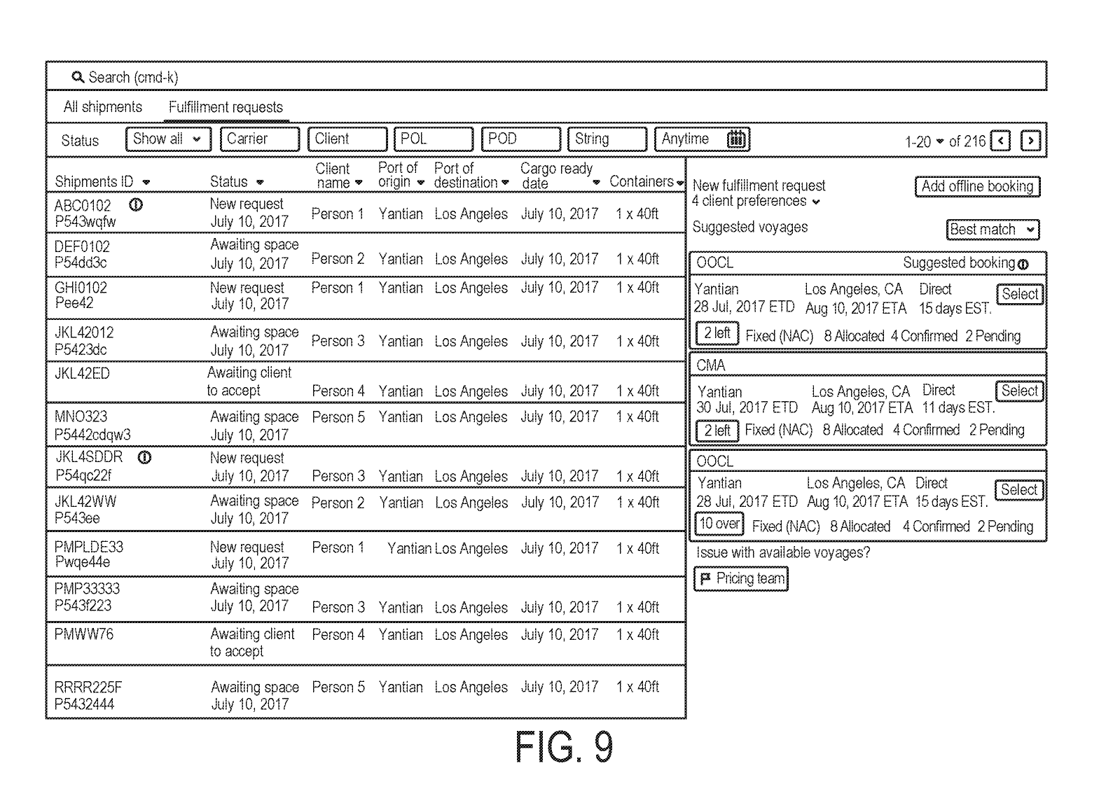

Disclosed herein is a new system for fulfillment of reservations (matching bookings and allocations, shifting, etc.), input data (booking and set allocations) and output data (maximum utilization of allocation pool fulfillment). FIG. 4 illustrates one example of how shifting mass presents opportunities for optimization. FIG. 9 is one illustrative example of a visual representation of a Carrier booking interface comprising Allocation information and suggested bookings for optimizing Allocation.

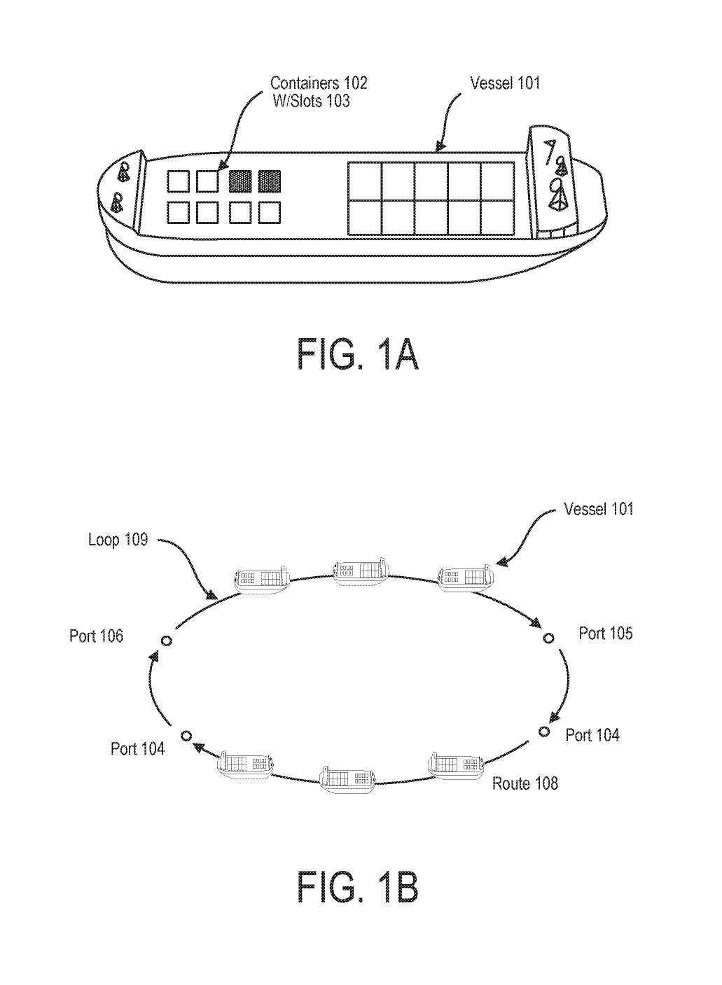

Disclosed herein is a new system for maximizing utilization of a freight forwarder's allocation. In one embodiment, 60 to 70 percent of the Allocation of Slots is optimized. In one embodiment, 70 to 80 percent of the Allocation of Slots is optimized. In one embodiment, 80 to 90 percent of the Allocation of Slots is optimized. In one embodiment, 90 to 100 percent of the Allocation of Slots is optimized. In one embodiment, 100 percent of the Allocation of Slots is optimized. FIG. 1A is one illustrative example of how Container 102 with Slots 103 are not all filled. The systems disclosed herein would optimize 100 percent of the available Slots.

Disclosed herein is a method of forecasting future demands for moving mass based on historical fulfillment data. In one embodiment, the historical fulfillment data comprises fulfillment of shipments. In one embodiment, the historical fulfillment data comprises cancellation of shipments.

Disclosed herein is a new system for optimizing percent fulfillment of an allocation by distributing shipping needs across some source of fixed volume in view of historical data. In one embodiment, the systems disclosed herein create a weighted model of macro/microeconomic factors guiding an ability to forecast future volume requirements and a method to then optimize the fulfillment of those volume allotments.

Disclosed herein is a new system for generating accurate forecasts of shipped volume and the successive future allocation of said volume across different Clients, Strings and Routes, thereby enabling better planning and increasing the utilization of contracted container shipment allocations.

In one embodiment, the systems disclosed herein maximize the utilization of contracted container shipment allocations. In one embodiment, the systems disclosed herein maximize the likelihood of shipped volume equating booked volume, thereby resulting in better allocations adjustments. In one embodiment, the systems disclosed herein increase consistent fulfillment of allocation requirements. In one embodiment, the systems disclosed herein provide a qualitative process for determining a Carrier value and prioritizing that value with respect to a Client's requirements. In one embodiment, the Carrier is ranked by previous historical fulfillment of shipments. In one embodiment, the Client reviews the Carrier's performance. FIG. 4 illustrates one example of how Mass Shifting Engine evaluates opportunities for optimizing space for moving mass.

In one embodiment, the systems disclosed herein compute a score for a Carrier. In one embodiment, the systems disclosed herein rank Carriers based on scores. In one embodiment, the systems disclosed herein rank Carriers by percent of fulfillment. In one embodiment, Carriers are ranked by consistent shipments.

In one embodiment, the systems disclosed herein are computerized and continuously repeated through an automated process, query and provision of data that consistently provides accurate forecasts of the arrangement of future allocation requirements and the planned utilization of meeting those requirements. In one embodiment, the systems disclosed herein anticipate future allocations based on historical data, e.g., percent fulfillment of a Carrier, lanes of consistent volume, etc. As used herein, the “historical data” may include any time window, including recent events (e.g., seconds, minutes, days, weeks, etc.) and/or long-passed events (e.g., years, decades, all time, etc.). In one embodiment, the “historical data” includes data conventionally described as “real-time,” presently available or contemporaneous.

Disclosed herein is an Allocation Management System, comprising:

a First Client having a First Physical, Concrete and Tangible Object, said First Object having a First Mass, a First Volume, a First Composition and a First Starting Position;

a Second Client having a Second Physical, Concrete and Tangible Object, said Second Object having a Second Mass, a Second Volume, and a Second Starting Position;

a First Carrier having a First Vessel, said First Vessel having a plurality of Slots;

a Second Carrier having a Second Vessel, said Second Vessel having a plurality of Slots;

a First Destination;

a Second Destination;

a First Route from the First Starting Position to the First Destination;

a Second Route from the Second Starting Position to the Second Destination;

a Freight Forwarder;

a First Allocation of Slots on the First Vessel;

a Second Allocation of Slots on the Second Vessel;

a First Reservation of Slots on the First Vessel;

a Second Reservation of Slots on the Second Vessel;

a First Fulfillment of Slots on the First Vessel;

a Second Fulfillment of Slots on the Second Vessel; and

a Mass Distribution Engine.

As used herein, the term “Client” refers to an entity controlling mass. In one embodiment, the Client is a human being. In one embodiment, the Client is a business. In one embodiment, the Client owns the mass. In one embodiment, the Client manages the mass. In one embodiment, the Client cares for the mass. In one embodiment, the Client creates the mass. In one embodiment, the Client possesses physical control of the mass. In one embodiment, the Client needs to move mass. In one embodiment, the Client engages with a Freight Forwarder to move mass. In one embodiment, there is a First Client. In one embodiment, there is a Second Client. In one embodiment, there is a Third Client. In one embodiment, there are more than three Clients. In one embodiment, the Client transfers control of the mass to a Consignee by transferring mass to a Freight Forwarder, selling mass to another person, shipping mass to another entity, or other methods.

As used herein, the term “Physical, Concrete and Tangible Object” refers to on object of matter. In one embodiment, the Physical, Concrete and Tangible Object is a product. In one embodiment, the Physical, Concrete and Tangible Object is a collection or plurality of products. In one embodiment, the Physical, Concrete and Tangible Object is a quantity, mass, weight and/or volume of products requiring utilization of a full container load (FCL). In one embodiment, the Physical, Concrete and Tangible Object is a quantity, mass, weight and/or volume of products requiring utilization of a less-than container load (LCL), e.g., a pallet. In one embodiment, the Physical, Concrete and Tangible Object is a pallet of products, e.g., a pallet of clothing, a pallet of electronic devices, a pallet of hazardous materials, etc., which may (or may not) be further segmented and packaged (placed into boxes).

As used herein, the term “Mass” refers to the matter making up an object. In one embodiment, Mass is expressed in metric units (grams, kilograms, etc.). In one embodiment, Mass is expressed in pounds. In one embodiment, there is a First Mass. In one embodiment, there is a Second Mass. In one embodiment, there is a Third Mass. In one embodiment, there are more than three Masses. In one embodiment, the Mass is a shirt. In one embodiment, the Mass is a shirt on a pallet. In one embodiment, the Mass is a shirt in a box or carton.

As used herein, the term “Volume” refers to the space occupied within a three-dimensional coordinate system. In one embodiment, Volume is expressed in metric units (cm3, m3, etc.). In one embodiment, the Volume is fixed. In one embodiment, the Volume changes. In one embodiment, there is a First Volume. In one embodiment, there is a Second Volume. In one embodiment, there is a Third Volume. In one embodiment, there are more than three Volumes. In one embodiment, the Volume is a box measuring 4 inches on all sides, which may or may not be filled with one or more objects, e.g., filled with shirts. In one embodiment, the Volume is an LCL.

Within the context of this disclosure, the term “volume” is used to describe three-dimensional space. In one embodiment, the term “volume” is used to describe the amount of mass moving, e.g., volume of shipments, volume of products, etc., often per unit per time.

As used herein, the term “Composition” refers to a material, materials, compound or compounds forming an object. In one embodiment, the Composition of the Physical, Concrete and Tangible Object is a textile, such as cotton making cotton clothing. In one embodiment, the Composition of the Physical, Concrete and Tangible Object is a food product, e.g., a canned beverage. In one embodiment, the Composition of the Physical, Concrete and Tangible Object is a hazardous material, e.g., an aerosol.

As used herein, the term “Starting Position” refers to a physical geographical location in which an object is defined to originate within the transportation process managed by the systems disclosed herein. In one embodiment, the Starting Position is expressed in longitude and latitude. In one embodiment, the Starting Position is a country. In one embodiment, the Starting Position is a city. In one embodiment, the Starting Position refers to the location of a Vessel (a plane, a train, a truck, a ship, etc.), at a port, a yard, a distribution center, factory, etc., on which a Physical, Concrete and Tangible Object begins its voyage. In one embodiment, the Starting Position is the beginning location of an ocean transportation leg, e.g., a port in Shanghai. In one embodiment, the Starting Position is a port in Los Angeles. In one embodiment, the Starting Position is a port in Singapore. In one embodiment, the Starting Position is a Port of Loading (POL).

As used herein, the term “Port of Loading” refers to the location in which a Physical, Concrete and Tangible Object is placed into a container, vessel or other apparatus. In one embodiment, the term “Port of Loading” refers to the “Place of Receipt;” for example, where the cargo is loaded into a container. In one embodiment, the term “Port of Loading” refers to the place at which a container is loaded onto a vessel. A Port of Loading is important for establishing where the Physical, Concrete and Tangible Object should move forward. In one embodiment, the Port of Loading is the same location as the Starting Position. In one embodiment, the Port of Loading is the same location as the First Destination. In one embodiment, the Port of Loading is a port in Shanghai. In one embodiment, the Port of Loading is a port in Thailand. In one embodiment, the Port of Loading is Los Angeles and the Port of Discharge is Shanghai. In one embodiment, the Port of Loading is Hong Kong and the Port of Discharge is Oakland. In one embodiment, a Carrier transports mass from a Port of Loading to a Port of Destination.

As used herein, the term “Carrier” refers to an entity capable of moving mass across a distance (water or land). In one embodiment, the Carrier is a business entity. In one embodiment, the Carrier controls a Vessel used for moving mass. In one embodiment, the Carrier controls more than one Vessel for moving mass. In one embodiment, the Carrier possesses and sells space aboard one or more vessels for shipping Physical, Concrete and Tangible Objects. In one embodiment, the Carrier offers a Slot on a Vessel of a String.

As used herein, the term “String” refers to an offer by a Carrier for moving mass on a scheduled day of departure through one or more parts of a defined path, such as a loop. In one embodiment, the String comprises an offer from a Port of Loading to a Port of Destination. In one embodiment, the String comprises a plurality of Vessels belonging to two or more different Carriers. In one embodiment, two Carriers are on the same String. In one embodiment, the String comprises an alliance of Carriers. In one embodiment, the String comprises a set of ports. In one embodiment, the String comprises a specific schedule. In one embodiment, the String comprises a regularly scheduled departure day, e.g., a specific day of the week.

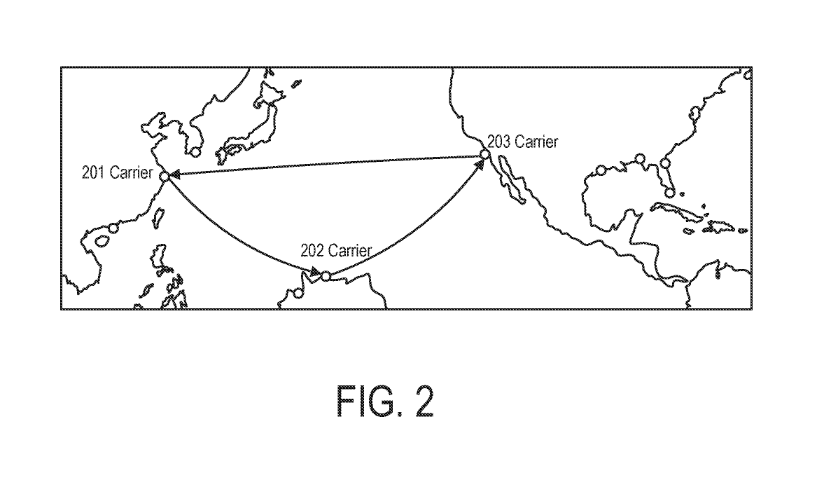

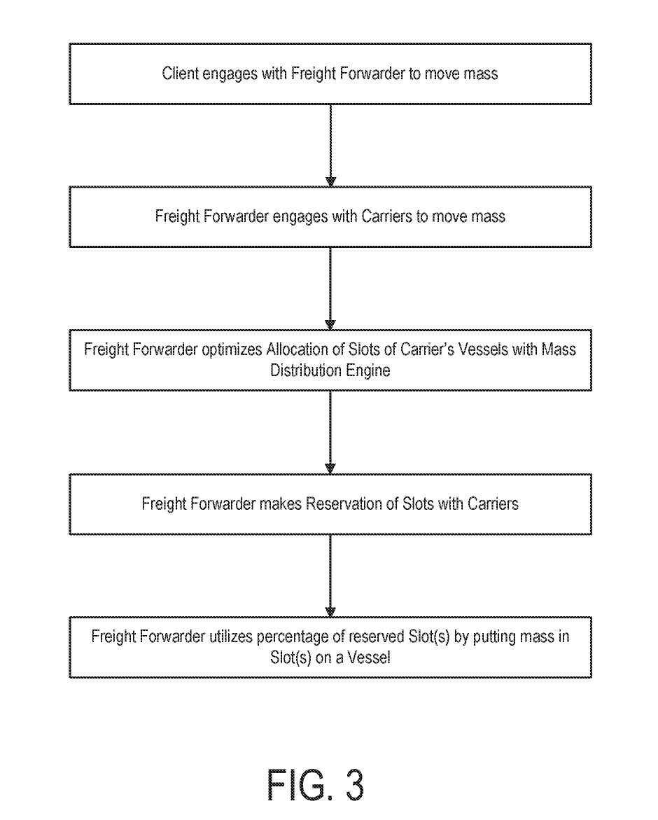

In one embodiment, the term “String” refers to a procession of Vessels belonging a particular carrier in a circular direction along a fixed schedule of ports with a fixed departure day of the week set for each port. FIG. 2 is an illustrative example of Carriers 201, 202 and 203 following the same path or loop within their individual strings. In one embodiment, a String comprises a Carrier offering to transport mass on particular days along a loop connecting Ningbo to Shanghai to Los Angeles to Oakland and back to Ningbo to repeat the loop. In one embodiment, the String comprises a Carrier, Port of Destination and Port of Loading where that combination describes the main voyage of a given String. In one embodiment, each String is Carrier specific but consists of different subsets of Port of Destinations and Port of Loadings combinations between the Starting Position and the Destination.

As used herein, the term “Alliance” refers to two or more Carriers working cooperatively. For example, within the context of ocean Carriers, a Vessel owned by a First Carrier could be sailing on a Second Carrier's String or vice versa. In one embodiment, all Carriers within an alliance pool together their fleets of Vessels, moving containers on one mothers' behalf to extend their service offerings and geographic coverage. In one embodiment, the Carriers in an Alliance contribute a certain number of Vessels to a “loop” and allow each other to use the Vessel, e.g., a First Carrier could offer space on a Vessel owned and operated by a Second Carrier. In one example, to allocate space for a shipment from Yantian to Long Beach, the shipment is booked on a First Carrier's String, e.g., “TP3,” or on a Second Carrier's String, e.g., “Sequoia.” In this illustrative example, essentially the same loop is served, yet depending on when the shipment takes place, the shipment could be on a First Carrier Vessel or a Second Carrier Vessel. In one example, the main variable in determining the “String” is not who owns the ship or Vessel but who sells the Slot on that Vessel.

As used herein, the term “loop” refers to a sequence of geographic points, e.g., ports, through which Vessels circulate. Multiple Carriers (and therefore multiple Vessels) may follow the same loop. Accordingly, the same “loop” may include multiple different Strings because different carriers may make different offerings for transporting mass along the same loop. In one example, a loop comprises the following ports from Shanghai, Hong Kong, Seattle and Long Beach. Virtually any set of contiguous points may serve as a loop. FIG. 1B illustrates Vessel 101 traveling along Loop 109 to Ports 104, 105, 106 and 107.

As used herein, the term “Vessel” refers to a machine for moving mass across a distance. In one embodiment, the Vessel is a vehicle. In one embodiment, the Vessel is a ship. In one embodiment, the Vessel is a plane. In one embodiment, the Vessel is a train. In one embodiment, the Vessel is a truck. In one embodiment, there is a First Vessel. In one embodiment, there is a Second Vessel. In one embodiment, there is a Third Vessel. In one embodiment, there more than three Vessels.

As used herein, the term “Slot” refers to a space available for mass. In one embodiment, the term “Slot” refers to a space suitable for a container. In one embodiment, the term “Slot” refers to space available within a container. In one embodiment, the term “Slot” refers to a space available for placing a container on a Vessel, e.g., a ship. In one embodiment, the Slot is a space fitting the requirements by a Client, e.g., a Slot on a Vessel on a departure day. In one embodiment, mass is shifted between Slots for optimization, e.g., switching masses to leave on different days. In one embodiment, the Slots are a set amount for a period of time, a week, a month, a year, etc.

As used herein, the term “Destination” refers to a physical, geographical location to which an object is moved. In one embodiment, the Destination is a location for which mass is intended to remain stationary after movement. In one embodiment, the Destination is one of a series of Destination points. In one embodiment, the Destination is the final location of an ocean leg. In one embodiment, the movement of mass comprises a First Destination. In one embodiment, the movement of mass comprises a Second Destination. In one embodiment, the movement of mass comprises a Third Destination. In one embodiment, the movement of mass comprises more than three Destinations. In one embodiment, the Destination is a Port of Discharge (POD). In one embodiment, the Destination is Seattle. In one embodiment, the Destination is Amsterdam. In one embodiment, the Destination is New York. In one embodiment, the Destination is Tuticorin.

As used herein, the term “Port of Discharge” refers to a location from which mass is removed from a Carrier's authority. In one embodiment, the Port of Discharge is the same location as the Destination. In one embodiment, the Port of Discharge is the location where mass is removed from a container. In one embodiment, the Port of Discharge is the location where a Consignee relinquished control of mass. In one embodiment, the Port of Discharge is Long Beach. In one embodiment, the Port of Discharge is New York. In one embodiment, the Port of Discharge is Oakland. In one embodiment, the Port of Discharge is where mass is removed from a container. In one embodiment, the Port of Discharge is where a Client sends mass. In one embodiment, the Port of Discharge is where the consignee is located. In one embodiment, the Port of Discharge is Los Angeles and the Port of Loading is Thailand. In one embodiment, the Port of Discharge is Seattle and the Port of Loading is Japan.

In one embodiment, the Physical, Concrete and Tangible Object is divided into portions, and each portion is sent to a location, which may be the same or different location. In one embodiment, the Port of Discharge is the last location in which the Carrier warrants the Physical, Concrete and Tangible Object. In one embodiment, the Port of Discharge is a port. In one embodiment, the Port of Discharge is an airplane hanger. In one embodiment, the Port of Discharge is a rail. In one embodiment, the Port of Discharge is a distribution center.

As used herein, the term “Route” refers to a path through which mass moves from one location to another. In one embodiment, the Route is the movement of mass from a Starting Point to a Destination. In one embodiment, the Route comprises multiple stops. In one embodiment, the Route is a single continuous path through which mass moves. In one embodiment, the Route is divided into portions that can be taken together to form a path from one point to another. In one embodiment, the Route comprises a series of two or more points through which mass moves. In one embodiment, the Route is measured in distance, e.g., miles, kilometers, etc. In one embodiment, the Route is measured in time, e.g., days, hours, minutes, etc. In one embodiment, the Route is measured in distance and time. In one embodiment, the Route comprises a ship moving from a port in Shanghai to a port in Los Angeles. In one embodiment, the Route comprises a mass moving from Thailand to New York to San Francisco. In one illustrative example, FIG. 1B represents Vessel 101 moving along Route 108 comprising Ports 104, 105, 106, and 107 on Loop 109.

As used herein, the term “Freight Forwarder” refers to an entity possessing temporary control of mass. In one embodiment, the Freight Forwarder engages in a contractual relationship with a Client to possess mass. In one embodiment, the Freight Forwarder engages in a contractual relationship with a Carrier to move mass. In one embodiment, the Freight Forwarder warrants possession of mass. In one embodiment, the Freight Forwarder maximizes allocation of space for a Carrier. In one embodiment, the Freight Forwarder optimizes movement of mass from multiple Clients. In one embodiment, the Freight Forwarder optimizes movement of mass through consolidating mass.

As used herein, the term “Allocation of Slots” refers to a distribution or assignment of space on a Vessel available for moving mass, e.g., a container of objects, from one location to another. In one embodiment, a Carrier allocates Slots to a party with mass, e.g., a Freight Forwarder. In one embodiment, the Freight Forwarder optimizes the Allocation of Slots to Clients. Various conditions and requirements determine how different Physical, Concrete and Tangible Objects are stored in the same container, e.g., the type of Vessel. In one embodiment, rules and regulations for hazardous materials (“hazmats”) dictate how certain types of Physical, Concrete and Tangible Objects may (or may not) share the same container, e.g., chemicals may not be stored with perishable foods or be on the same Vessel. In one embodiment, the Client dictates that certain Physical, Concrete and Tangible Objects may not be stored together, e.g., fragile materials with blunt objects. In one embodiment, the Allocation of Slots is determined according to the day of arrival at a Destination. In one embodiment, the Allocation of Slots is determined according to the Vessel. In one embodiment, the Allocation of Slots is determined according to the historical data of fulfillment. In one embodiment, the Allocation of Slots is determined according to the Carrier's history of fulfillment.

In one embodiment, the Allocation of Slots is measured in container units. In one embodiment, the Allocation of Slots is represented in Twenty-Foot-Equivalent Units.

As used herein, the term “Twenty-Foot-Equivalent Unit,” or “TEU,” refers to a unit of capacity of a container, i.e., a 20-foot container.

In one embodiment, Allocation of Slots are measured in container units. In one embodiment, Allocation of Slots are represented in Forty-Foot-Equivalent Units.

As used herein, the term “Forty-Foot-Equivalent Unit,” or “FEU,” refers to a unit of capacity of a container, i.e., a 40-foot container. In one embodiment, the FEU is two 20-foot containers. In one embodiment, the FEU is a 40-foot container. In one embodiment, the FEU is a 40-foot-high Cube container.

In one embodiment, the Allocation of Slots is a negotiated amount expressed in TEU. In one embodiment, the Allocation of Slots is a negotiated amount expressed in TEU shipped weekly. In one embodiment, the Allocation of Slots is a negotiated amount expressed in TEU shipped weekly on an ocean leg. In one embodiment, the Allocation of Slots is a negotiated amount expressed in TEU shipped weekly on a String per Carrier.

In one embodiment, the Allocation of Slots is a negotiated amount expressed in FEU. In one embodiment, the Allocation of Slots is a negotiated amount expressed in FEU shipped weekly. In one embodiment, the Allocation of Slots is a negotiated amount expressed in FEU shipped weekly on an ocean leg. In one embodiment, the Allocation of Slots is a negotiated amount expressed in FEU shipped weekly on a String per Carrier.

As used herein, the term “Reservation of Slots” refers to an occupation of space for moving mass on a particular String at some time in the future. In one embodiment, the systems disclosed herein comprise a First Reservation of Slots. In one embodiment, the systems disclosed herein comprise a Second Reservation of Slots. In one embodiment, the systems disclosed herein comprise a Third Reservation of Slots. In one embodiment, the systems disclosed herein comprise more than three Reservations of Slots. In one embodiment, the Reservation of Slots is expressed in TEU. In one embodiment, the Reservation of Slots is expressed in FEU. In one embodiment, the Reservation of Slots refers to the occupation of space on a ship. In one embodiment, a Freight Forwarder makes a Reservation of Slots with a Carrier pursuant to a Client's request. In one embodiment, a Freight Forwarder makes a Reservation of Slots pursuant to the type of mass. In one embodiment, a Freight Forwarder makes a Reservation of Slots pursuant to the amount of mass. In one embodiment, a Freight Forwarder makes a Reservation of Slots pursuant to the amount of TEUs needed. In one embodiment, a Freight Forwarder makes a Reservation of Slots pursuant to the amount of FEUs needed. In one embodiment, a Freight Forwarder makes a Reservation of Slots pursuant to a Client's requirements.

As used herein, the term “Mass Distribution Engine” refers to an optimization tool for fulfilling the amount of space allocated with each Carrier, i.e., the Allocation of Slots from each Carrier. In one embodiment, the Mass Distribution Engine optimizes 60 to 90 percent of a Carrier's fulfillment of Allocation of Slots. In one embodiment, the Mass Distribution Engine optimizes 70 to 95 percent of a Carrier's fulfillment of Allocation of Slots. In one embodiment, the Mass Distribution Engine optimizes 80 to 99 percent of a Carrier's fulfillment of Allocation of Slots. In one embodiment, the Mass Distribution Engine optimizes 90 to 100 percent of a Carrier's fulfillment of Allocation of Slots. In one embodiment, the Mass Distribution Engine optimizes exactly 100 percent of a Carrier's fulfillment of Allocation of Slots. In one embodiment, the Mass Distribution Engine optimizes a Carrier's fulfillment of Allocation of Slots by maximizing Volume.

As used herein, the term “optimizes fulfillment of allocations” refers to the systems disclosed herein that purposefully select space, e.g., particular Strings or Carriers, to use 100 percent of the allocation of space provided. In one embodiment, the Mass Distribution Engine allocates mass to fulfill 100 percent of the space provided by a Carrier. In one embodiment, the Mass Distribution Engine allocates mass to fulfill 100 percent of the space on a Vessel. In one embodiment, the Mass Distribution Engine allocates mass to fulfill 100 percent of the space provided in a contracting period.

In one embodiment, the Mass Distribution Engine optimizes fulfillment of Allocation of Slots by reserving Slots with particular Carriers pursuant to percent allocation utilized while also satisfying a Client's requirements for moving the mass. In one embodiment, the Mass Distribution Engine optimizes fulfillment of Allocation of Slots by making Reservation of Slots with particular carriers pursuant to a Freight Forwarder's 100 percent fulfillment of allocation goal. In one embodiment, the Mass Distribution Engine optimizes fulfillment of Allocation of Slots by making a Reservation of Slots with particular Carriers pursuant to a Client's requirements and a Freight Forwarder's 100 percent fulfillment goal.

In one embodiment, the Mass Distribution Engine places a particular object or mass on a particular Vessel based on historical data for a particular String. In one embodiment, the Mass Distribution Engine evaluates historical shipment volume and reserves Slots on particular Strings pursuant thereto. In one embodiment, the Mass Distribution Engine reviews current shipment volume for allocating space. In one embodiment, the Mass Distribution Engine reviews weekly shipment volume for allocating space. In one embodiment, the Mass Distribution Engine anticipates future shipment volume from current Clients contributing to current and historical shipment volume. In one embodiment, the Mass Distribution Engine accounts for allocated space for the next week for anticipating future shipment volume. In one embodiment, the Mass Distribution Engine accounts for allocated space for the two weeks for anticipating future shipment volume. In one embodiment, the Mass Distribution Engine accounts for allocated space for the next three weeks for anticipating future shipment volume. In one embodiment, the Mass Distribution Engine accounts for allocated space for the next four weeks for anticipating future shipment volume.

In one embodiment, the Mass Distribution Engine utilizes Quantitative Forecasts for anticipation of allocation. In one embodiment, the Quantitative Forecast comprises a Quarterly Moving Average Method, e.g., the average volume projection of the previous 90 days. In one embodiment, the Quantitative Forecast comprises an Exponential Smoothing Method, in which the volume projection of the next period, weights more recent periods more heavily than older periods, e.g., a projection based on all historical data with a greater weight on recent volume than older volume. In one embodiment, the Quantitative Forecast comprises Seasonal Indices Weighting, in which is volume projection accounting for past seasonal business trends and weights the forecast accordingly.

In one embodiment, the Mass Distribution Engine places a particular object or mass on a particular Vessel based on output factors. In one embodiment, the Mass Distribution Engine accounts for weekly allocations as a function of shipping volume. In one embodiment, the Mass Distribution Engine determines lanes with consistent shipping volume, e.g., high frequency of shipments, low variance of volume, etc. In one embodiment, the Mass Distribution Engine reserves Slots on Vessels serving lanes of consistent volume. FIG. 1 is an illustrative example of Vessel 101 with Containers 102 comprising Slots 103.

As used herein, the term “lanes of consistent volume” refers to the movement of mass on a predictable, reliable basis. In one embodiment, the lanes of consistent volume comprise consistent mass per unit time along the same path, e.g., a constant amount of mass moving per week. In one embodiment, the term “volume” is used to describe the amount of space occupied by an object. In one embodiment, the term “volume” refers to an amount or quantity, such as within the context of “lanes of consistent volume,” which refers to the movement of mass on a Carrier per week. In one embodiment, the lanes of consistent volume refer to the movement of mass by a String on a weekly basis. In one embodiment, the lanes of consistent volume refer to the movement of mass on a Route on a weekly basis. In one embodiment, the lanes of consistent volume refer to the amount of mass moving from Shanghai to Oakland to Los Angeles.

In one embodiment, the Mass Distribution Engine identifies Clients that ship consistently for each consistent lane. In one embodiment, for each consistent lane, the Mass Distribution Engine determines whether the Client requires a specific Carrier. In one embodiment, the Mass Distribution Engine identifies consistent shipping volume by Client. In one embodiment, the Mass Distribution Engine identifies consistent shipping volume by Carrier. In one embodiment, the Mass Distribution Engine identifies consistent shipping volume by each consistent lane of volume.

In one embodiment, the Mass Distribution Engine budgets allocated space.

As used herein, the term “budget” refers to the management of allocated space. In one embodiment, a Carrier provides a Freight Forwarder a set amount of Slots for a period of time, i.e., a contracting period. In one embodiment, a Carrier provides a Freight Forwarder a set amount of Slots for a week. In one embodiment, a Carrier provides a Freight Forwarder a set amount of Slots for a month. In one embodiment, a Carrier provides a Freight Forwarder a set amount of Slots for a year. In one embodiment, budgeting allocated space comprises the Mass Distribution Engine, accounting for factors affecting the supply, demand and utilization of space on a vessel throughout the process of reserving and utilizing such space, including but not limited to 1) the space, e.g., Slots, allocated for a period of time, 2) the Freight Forwarder's rate of utilizing the space allocated, and/or 3) a carrier's historical amount of space released versus space allocated. In budgeting allocated space, the Mass Distribution Engine makes recommendations based on 100 percent utilization goal. In budgeting allocated space, the Mass Distribution Engine identifies opportunities for shifting mass based on 100 percent allocation goal.

In one embodiment, the Mass Distribution Engine budgets the optimization at all times during the contracting period. For example, the Mass Distribution Engine recognizes six months into a one year contracting period that 70 percent of the space is allocated. In response, the Mass Distribution Engine will budget the remaining 30 percent of space to last the final six months.

In one embodiment, the Mass Distribution Engine defines a Hard Allocation Pool, including, for example, space guaranteed by the carrier and/or volume guaranteed by the freight forwarder.

As used herein, the term “Hard Allocation Pool” refers to a collection of space based on the qualitative rating of Carriers and Client requirements as well as considering the minimum quantity committed (MQC) with each Carrier. In one embodiment, the Client requirements are chosen from price, transit time, reliability (e.g., on-time reliability), sailing frequency, amount of cargo rolled, cargo cutoff, terminal preferences, required free days and routing preferences. As used herein, the term “required free days” refers to days that the container is needed outside the port or before pickup at the port. However, this list of Client requirements is not intended to be exclusive.

In one embodiment, the Mass Distribution Engine budgets space based on the Hard Allocation Pool.

In one embodiment, the Mass Distribution Engine defines a Soft Allocation Pool.

In general, the Mass Distribution Engine evaluates factors (e.g., client requirements or other requirements) from the perspective of a freight forwarder, including client preferences and/or carrier preferences. Client preferences include, for example, sell price (does the client have a customized rate with the carrier, aka, is the client a named account with the carrier), transit time, reliability, sailing frequency, cargo cutoff, terminal preferences, required free days (days that the container is needed outside the port or before pickup at the port), routing preferences, carrier preferences, etc. Carrier preferences include, for example, fixed-to-floating ratio requirements, aggregated minimum volume committed, volume committed per string, credit terms, buy price and how often does cargo get rolled. As used herein, the term “rolled” refers to situations in which the cargo gets delayed by a period of time (such as a week) if the vessel was overbooked, etc.

As used herein, the term “Soft Allocation Pool” refers to space available on a short term, promotional and/or specific request basis. In one embodiment, space within a Soft Allocation Pool is made available from the forwarder to the carrier. In one embodiment, space within a Soft Allocation Pool is made available from the carrier to forwarder.

One benefit of including a Soft Allocation Pool within the Mass Distribution Engine of this disclosure is utilizing last minute space adjustments and exceeding allotments; for example, when the carrier needs more volume and/or the forwarder needs more volume.

In one embodiment, the Mass Distribution Engine defines a Hybrid Allocation Pool, comprising a Hard Allocation Pool and a Soft Allocation Pool.

For example, Carrier A and Carrier B have the same contracting period of one year with the same start date, but Carrier A has a higher ranking than Carrier B. Six months into the contracting period, Carrier A has 60 percent optimization of space and Carrier B has 40 percent optimization of space. The Mass Distribution Engine will prioritize the optimization of Carrier A despite Carrier B having more available space based on Carrier A's higher ranking.

In one embodiment, the systems disclosed herein comprise a Mass Shifting Engine.

As used herein, the term “Mass Shifting Engine” refers to an optimization tool for changing a Reservation of Slots for purposes of optimizing fulfillment of allocations. In one embodiment, the Mass Shifting Engine redistributes Physical, Concrete and Tangible Objects from one container to another. In one embodiment, the Mass Shifting Engine exchanges a First Physical, Concrete and Tangible Object with a second Physical, Concrete and Tangible Object within the same container. In one embodiment, the Mass Shifting Engine engages with a Carrier to execute the physical redistribution of a Physical, Concrete and Tangible Object. In one embodiment, the Mass Shifting Engine exchanges a First Physical, Concrete and Tangible Object within a first container with a second Physical, Concrete and Tangible Object within a second container. In one embodiment, the Mass Shifting Engine accounts for a Client's requirements and shifts mass to accommodate said Client's requirements. In one example, the Physical, Concrete and Tangible Object must be placed in a container with low humidity. In one example, the Physical, Concrete and Tangible Object must be placed in a heat resistant container. In one embodiment, the Mass Shifting Engine shifts mass from one Vessel to another Vessel. In one embodiment, the Mass Shifting Engine shifts mass from one Carrier to another Carrier. In one embodiment, the Mass Shifting Engine shifts mass from one String to another String. In one embodiment, the Mass Shifting Engine shifts mass from one lane to another lane. In one embodiment, the Mass Shifting Engine shifts mass from one loop to another loop.

In one embodiment, the systems disclosed herein comprise a Freight Forwarder Performance Measurement Tool.

As used herein, the term “Freight Forwarder Performance Measurement Tool” refers to an instrument for evaluating fulfillment of allocations for a given Carrier or collection of Carriers.

In one embodiment, the Freight Forwarder Performance Measurement Tool evaluates the percent of allocation fulfilled, e.g., the amount of fulfilled shipments divided by the total allocation available at time of shipment. In one embodiment, the percent of allocation fulfilled is presented by day. In one embodiment, the percent of allocation fulfilled is presented by week. In one embodiment, the percent of allocation fulfilled is presented by month. In one embodiment, the percent of allocation fulfilled is presented by year. In one embodiment, the percent of allocation fulfilled is measured by Carrier. In one embodiment, the percent of allocation fulfilled is measured by lanes of consistent volume. In one embodiment, the percent of allocation fulfilled is measured by String. In one embodiment, the percent of allocation fulfilled is measured by Route.

In one embodiment, the Freight Forwarder Performance Measurement Tool evaluates the percent of allocation remaining, e.g., (the amount of allocation available minus the amount of fulfilled shipments) divided by (the amount of allocation available). In one embodiment, the percent of allocation remaining is presented by day. In one embodiment, the percent of allocation remaining is presented by week. In one embodiment, the percent of allocation remaining is presented by month. In one embodiment, the percent of allocation remaining is presented by year. In one embodiment, the percent of allocation remaining is measured by Carrier. In one embodiment, the percent of allocation remaining is measured by lanes of consistent volume. In one embodiment, the percent of allocation remaining is measured by String. In one embodiment, the percent of allocation remaining is measured by Route.

In one embodiment, the systems disclosed herein comprise a Client Quality Measurement Tool.

As used herein, the term “Client Quality Measurement Tool” refers to an instrument for determining whether (and to what degree) a Client's requirements were met and how well they were satisfied. In one embodiment, the Client Quality Measurement Tool measures whether the price for a service was satisfactory by the Client. In one embodiment, the Client Quality Measurement Tool measures whether the mass was delivered on time as requested by the Client. In one embodiment, the Client Quality Measurement Tool measures whether the mass was damaged during transportation. In one embodiment, the Client Quality Measurement Tool comprises confirming a Reservation of Slots. In one embodiment, the Client Quality Measurement Tool comprises reviewing historical use of reserved slots. In one embodiment, the Client Quality Measurement Tool comprises Client's fulfilling bookings. In one embodiment, the Client Quality Measurement Tool communicates with the Mass Shifting Engine to shift mass to accommodate a particular Client's requirements.

In one embodiment, the Mass Distribution Engine optimizes fulfillment of allocations. In one embodiment, the Mass Distribution Engine determines the percent of allocation fulfilled with a particular carrier. In one embodiment, the Mass Distribution Engine compares the percent of allocation fulfilled with an expectation of a demand for Slots at a particular time within a contract period. In one embodiment, the Mass Distribution Engine identifies alternative Carriers for moving mass. In one embodiment, the Mass Distribution Engine determines the percent of allocation fulfilled of the alternative Carriers. In one embodiment, the Mass Distribution Engine determines the best option for moving mass to allocate 100 percent of space with each Carrier.

In one embodiment, the Mass Shifting Engine identifies an Alternative Slot on an Alternative Vessel.

As used herein, the term “Alternative Slot” refers to space available for a Physical, Concrete and Tangible Object when said Physical, Concrete and Tangible Object is already in a reserved space. In one embodiment, the Alternative Slot is on the same Vessel. In one embodiment, the Alternative Slot is with a different Carrier. In one embodiment, the Alternative Slot is on a different Vessel. In one embodiment, the Alternative Slot is with a Carrier with a lower percentage of its allocation met. In one embodiment, the Alternative Slot is space in a container. In one embodiment, the Alternative Slot is space within a different container when the container is an LCL. In one embodiment, the Alternative Slot is on a different String. In one embodiment, the Alternative Slot is for a different time, e.g., day, month, etc.

As used herein, the term “Alternative Vessel” refers to a machine available for moving mass. In one embodiment, the Alternative Vessel is with the same Carrier. In one embodiment, the Alternative Vessel is with a different Carrier. In one embodiment, the Alternative Vessel is with a different Carrier on the same String. In one embodiment, the Alternative Vessel is with a different Carrier within the same Alliance.

In one embodiment, the systems disclosed herein comprise a physical, tangible display means. For example, the systems disclosed herein may be implemented as part of a computer software package.

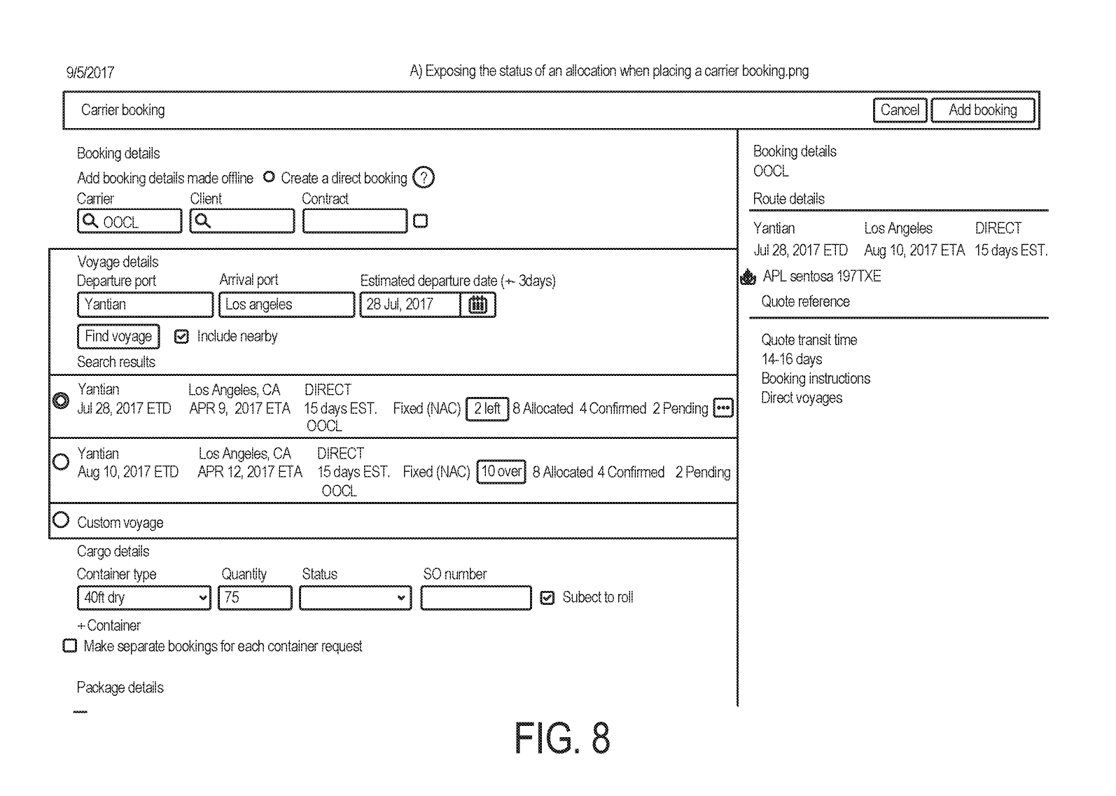

As used herein, the term “physical, tangible display means” refers to a visual medium for presenting information. In one embodiment, the physical, tangible display means comprises a graphical user interface. In one embodiment, the physical, tangible display means comprises a screen. In one embodiment, the physical, tangible display means comprises a computer. In one embodiment, the physical, tangible display means comprises a mobile device. In one embodiment, the physical, tangible display means comprises paper, e.g., a facsimile or print out. FIG. 8 is one illustrative example of a visual representation of a Carrier booking interface comprising Allocation information.

In one embodiment, the physical, tangible display means presents a visual representation of Allocation and Confirmation.

In one embodiment, the physical, tangible display means presents a visual representation of Port of Loading and Port of Destination.

In one embodiment, the physical, tangible display means presents a visual representation of a String and a Carrier.

In one embodiment, the physical, tangible display means presents a visual representation of a Date.

In one embodiment, the physical, tangible display means presents a visual representation of a Rank of a Carrier.

In one embodiment, the physical, tangible display means comprises any/all representations of percents used/complete of allocations, e.g., pie charts, graphs, etc.

In one embodiment, the physical, tangible display means presents a visual representation of availability of space using a color scheme.

As used herein, the term “color scheme” refers to a system in which colors are used to convey particular meaning. In one embodiment, colors are assigned certain meanings allowing for quick and efficient presentation of information.

In one illustrative example, presenting information in one particular color, e.g., grey, means there is no allocation.

In one illustrative example, presenting information in one particular color, e.g., red, means 80 percent of the allocation is fulfilled.

In one illustrative example, presenting information in one particular color, e.g., orange, means 80 to 100 percent of the allocation is fulfilled.

In one illustrative example, presenting information in one particular color, e.g., green, means 100 to 105 percent of the allocation is fulfilled.

In one illustrative example, presenting information in one particular color, e.g., blue, means over 105 percent of the allocation is fulfilled.

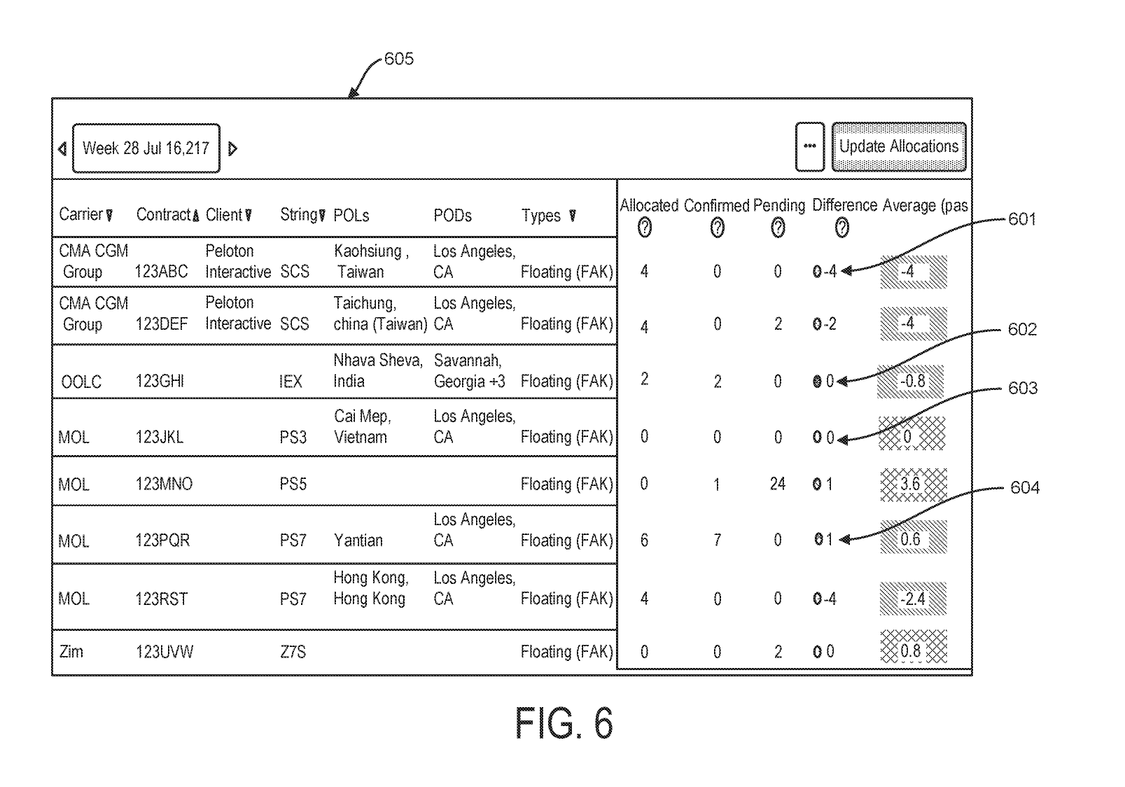

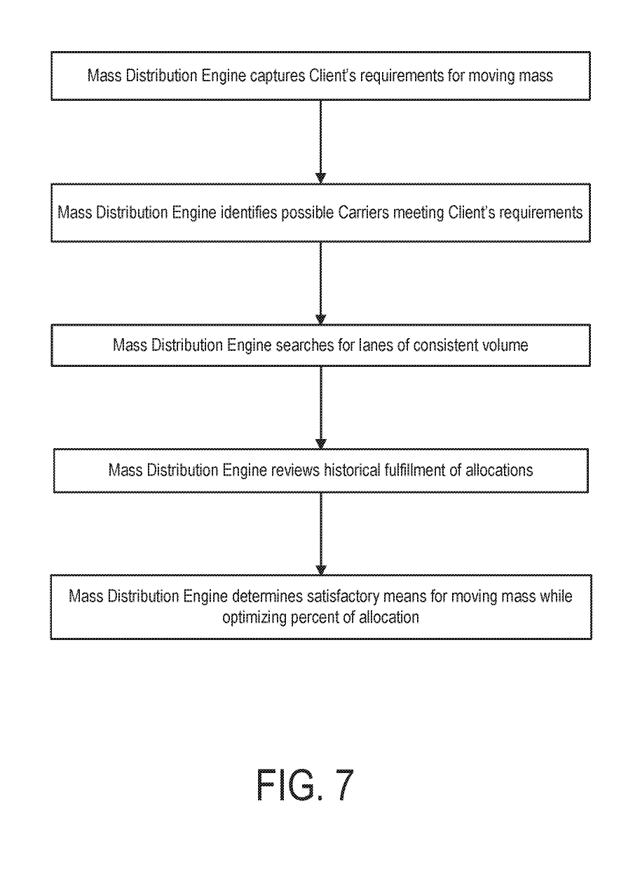

In one illustrative example, FIG. 6 is a color scheme of the systems disclosed herein.

In one illustrative example, presenting information in one particular color, e.g., yellow, means less than 100 percent of the allocation is fulfilled.

In one illustrative example, presenting information in one particular color, e.g., green, means 100 percent of the allocation is fulfilled.

In one illustrative example, presenting information in one particular color, e.g., red, means more than 100 percent of the allocation is fulfilled.

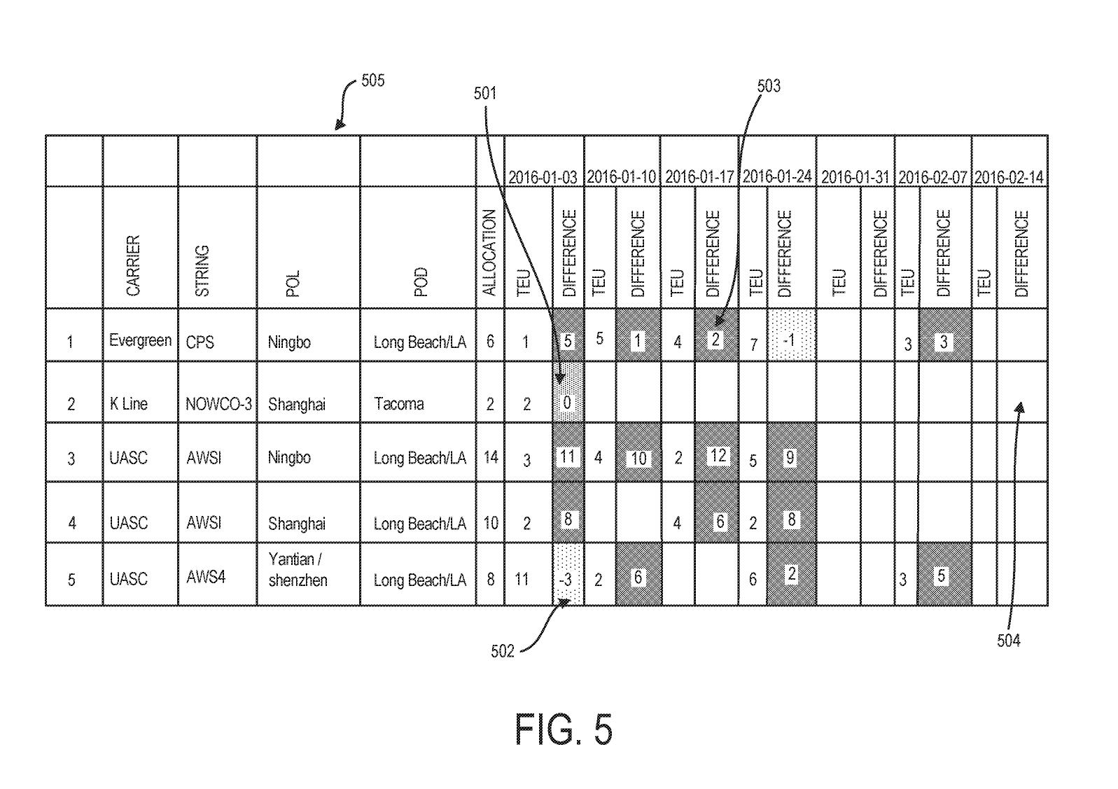

In one illustrative example, FIG. 5 is a color scheme of the systems disclosed herein.

In one embodiment, the systems disclosed herein presents an Allocation Overview on a physical, tangible display means.

As used herein, the term “Allocation Overview” refers to a visual representation of how Carriers measure the utilization of allocations. In one embodiment, the Carrier counts every shipment on a String. In one embodiment, the Carrier issues allocations that are String and/or Port of Loading specific. In one embodiment, the Carrier issues allocations that are String and/or Port of Destination specific. In one embodiment, the Carrier issues allocations that are String, Port of Loading and/or Port of Destination specific. In one embodiment, the Allocation Overview comprises any/all color combinations.

Although the present invention herein has been described with reference to various exemplary embodiments, it is to be understood that these embodiments are merely illustrative of the principles and applications of the present invention. Those having skill in the art would recognize that various modifications to the exemplary embodiments may be made without departing from the scope of the invention.

Moreover, it should be understood that various features and/or characteristics of differing embodiments herein may be combined with one another. It is, therefore, to be understood that numerous modifications may be made to the illustrative embodiments and that other arrangements may be devised without departing from the scope of the invention.

Furthermore, other embodiments of the invention will be apparent to those skilled in the art from consideration of the specification and practice of the invention disclosed herein. It is intended that the specification and examples be considered as exemplary only and with a scope and spirit being indicated by the claims.

Finally, it is noted that, as used in this specification and the appended claims, the singular forms “a,” “an” and “the” include plural referents unless expressly and unequivocally limited to one referent and vice versa. As used herein, the term “include” or “comprising” and its grammatical variants are intended to be non-limiting, such that recitation of an item or items is not to the exclusion of other like items that can be substituted or added to the recited item(s).

What is claimed is:

1. An Allocation Management System, comprising:
a First Client having a First Physical, Concrete and Tangible Object, said First Object having a First Mass, a First Volume, a First Composition and a First Starting Position;
a Second Client having a Second Physical, Concrete and Tangible Object, said Second Object having a Second Mass, a Second Volume and a Second Starting Position;
a First Carrier having a First Vessel, said First Vessel having a plurality of Slots;
a Second Carrier having a Second Vessel, said Second Vessel having a plurality of Slots;
a First Destination;
a Second Destination;
a First Route from the First Starting Position to the First Destination;
a Second Route from the Second Starting Position to the Second Destination;
a Freight Forwarder;
a First Allocation of Slots on the First Vessel;
a Second Allocation of Slots on the Second Vessel;
a First Reservation of Slots on the First Vessel;
a Second Reservation of Slots on the Second Vessel;
a First Fulfillment of Slots on the First Vessel;
a Second Fulfillment of Slots on the Second Vessel; and
a Mass Distribution Engine.

2. The Allocation Management System of claim 1, comprising a Mass Shifting Engine.

3. The Allocation Management System of claim 1, comprising a Freight Forwarder Performance Measurement Tool.

4. The Allocation Management System of claim 1, comprising a Client Quality Measurement Tool.

5. The Allocation Management System of claim 1, wherein the Mass Distributor Engine optimizes fulfillment of allocations.

6. The Allocation Management System of claim 1, wherein the Mass Shifting Engine identifies an Alternative Slot on an Alternative Vessel.

7. The Allocation Management System of claim 1, comprising determining lanes with consistent volume.

8. The Allocation Management System of claim 1, comprising reserving Slots on Vessels sailing on lanes with consistent volume.

9. The Allocation Management System of claim 1, comprising a physical, tangible display means.

10. The Allocation Management System of claim 9, wherein the display means presents Allocation and Confirmation.

11. The Allocation Management System of claim 10, wherein the display means presents Port of Loading and Port of Destination.

12. The Allocation Management System of claim 9, wherein the display means presents availability of space using a color scheme.

13. The Allocation Management System of claim 9, wherein the display means presents allocation information during carrier booking.

14. The Allocation Management System of claim 9, wherein the said Allocation Management System facilitates fulfillment of a booking based on available slots furthering the fulfillment of a booking, an allocation from a carrier providing said available slots and a freight forwarder's fulfillment of the said allocation from a carrier providing said available slots.

15. The Allocation Management System of claim 14, wherein the said Allocation Management System facilitates fulfillment of a booking based on both (1) a freight forwarder's fulfillment of the said allocation from a carrier providing said available slots and (2) the elapsed percentage of the time period for the allocation from a carrier providing said available slots.
